(19) United States
(12) Patent Application Publication
(10) Pub. No.: US 2026/0056071 A1
(43) Pub. Date: Feb. 26, 2026

(54) PRESSING FORCE AND PULLING FORCE DETECTING CONTROLLER

(71) Applicant: NISSHA CO., LTD., Kyoto-shi, Kyoto (JP)

(72) Inventors: Yuji WATAZU, Kyoto-shi (JP); Tsutomu MIURA, Kyoto-shi (JP); Shin-ichi TSUCHIYA, Kyoto-shi (JP); Takuto SHIGENARI, Kyoto-shi (JP); Mayumi SHIMADA, Kyoto-shi (JP); Kengo FUKUDA, Kyoto-shi (JP); Fumi OBA, Kyoto-shi (JP)

(21) Appl. No.: 19/140,982

(22) PCT Filed: Nov. 13, 2023
(86) PCT No.: PCT/JP2023/040779

§ 371 Date: Jun. 18, 2025

(30) Foreign Application Priority Data
Dec. 19, 2022 (JP) 2022-201703

(51) Int. Cl. G01L 5/22; G01L 5/165

(52) U.S. Cl. CPC G01L 5/22; G01L 5/165

(57) ABSTRACT

A controller that detects a pressing force and a pulling force only by the movement of a fingertip is provided. The controller of the present invention that detects a pressing force and a pulling force includes a housing, a film-type three-axis force sensor, and an operating unit. The force sensor is disposed on the surface of the housing and is configured to detect forces along three axes applied by a finger of a user. The operating unit covers the surface of the active area of the force sensor. The operating unit also has a pressing surface to be pressed by a finger pad of the finger; and a constraining surface on which the finger is to be constrained such that when the finger moves in a direction away from the pressing surface, a pulling force is applied to the surface of the active area of the force sensor.

### TECHNICAL FIELD

The present invention relates to a controller that detects a pressing force and a pulling force only by the movement of a fingertip.

### BACKGROUND ART

In recent years, a film-type three-axis force sensor has been known as a device that provides user interface (UI) development sites with new ideas that cannot be achieved with a joystick, directional pad, mouse, or touch panel.

The film-type three-axis force sensor can detect a pressing force (pressure), a state where slipping is about to occur, and a slipping state, by measuring the forces in the directions of three axes (X-, Y-, Z-axes) at a contact point, and can enter actions, at one finger point, such as twisting, turning, and shifting, which cannot be controlled by conventional controllers. Measuring the amount (volume) of a force is possible beyond on/off judgment, thereby achieving control of speed, movement amount, or the like. Compared with a joystick or a directional pad, the direction and movement amount can be simultaneously input by a slight movement of a fingertip. In addition, a thin and light film-type sensor is used, allowing mounting on a curved surface.

Examples of the film-type three-axis force sensor as described above include a capacitance type. In the capacitance type, an upper electrode and a lower electrode are arranged facing each other with an air layer or an elastic layer between the electrodes, and a pressing force is calculated by utilizing the change in the capacitance value generated by a fluctuation of the distance between the electrodes when the pressing force is applied (see Patent Documents 1 and 2).

### CITATION LIST

### Patent Literature

Patent Document 1: WO 2020/059766
Patent Document 2: JP 2017-156126 A

### SUMMARY OF INVENTION

### Technical Problem

However, in the controller using the film-type three-axis force sensor in the related art, there is a limit to the movement of a fingertip that can be used for an input, even when the input can be performed by one finger. That is, the movement of the fingertip that is actually used is only the movement of pressing the surface of the film-type three-axis force sensor (including the movement of rubbing the surface as well as pressing down the surface). The Applicant has realized that if it is possible to detect not only a pressing force but also a pulling force, a wider variety of input can be achieved.

Thus, it is an object of the present invention to solve the above problems and to provide a controller that detects a pressing force and a pulling force only by the movement of a fingertip.

### Solution to Problem

A plurality of aspects will be described below as a means for solving the problem. These aspects can be arbitrarily combined as needed.

The controller that detects a pressing force and a pulling force, according to one aspect of the present invention, includes a housing, a film-type three-axis force sensor, and an operating unit. The film-type three-axis force sensor is disposed on the surface of the housing and is configured to detect forces along three axes applied by a finger of a user. The operating unit covers the surface of an active area of the film-type three-axis force sensor. The operating unit also has a pressing surface to be pressed by a pad of the finger and a constraining surface on which the finger is to be constrained such that when the finger moves in a direction away from the pressing surface, a pulling force is applied to the surface of the active area of the film-type three-axis force sensor.

In the controller that detects a pressing force and a pulling force described above, the constraining surface of the operating unit may consist of a surface on the finger side of a band covering the back of the finger.

In the controller that detects a pressing force and a pulling force described above, the band may be composed of two pieces and have a locking structure that switches between a state in which the finger is bound and a state in which the finger is released.

In the controller that detects a pressing force and a pulling force described above, the locking structure of the band may be a hook-and-loop fastener. In addition, the locking structure of the band may be a reusable type cable tie structure.

In the controller that detects a pressing force and a pulling force described above, the constraining surface of the operating unit may consist of a surface on the finger side of a clip that pinches the finger.

In the controller that detects a pressing force and a pulling force described above, the clip may be composed of a pair of resin protrusions that project from the pressing surface and surround the circumference of the finger from the opposite directions. The gap between the respective tips of the pair of resin protrusions is opened and closed by the elasticity of the resin protrusions.

In the controller that detects a pressing force and a pulling force described above, the film-type three-axis force sensor may be a capacitance type.

The controller that detects a pressing force and a pulling force described above may further include an orientation detection device that detects an operating orientation of the user and is used for calibration of the film-type three-axis force sensor.

### Advantageous Effects of Invention

A controller of the present invention can detect a pressing force and a pulling force only by the movement of a fingertip. As a result, a wider variety of input can be achieved.

### BRIEF DESCRIPTION OF DRAWINGS

FIG. 1 is a schematic diagram of a controller that detects a pressing force and a pulling force according to the present invention.

FIG. 2 is a schematic diagram illustrating an example of the form of an operating unit in the controller in FIG. 1.

FIG. 3 is a schematic diagram illustrating an example of a capacitive film-type three-axis force sensor.

FIG. 4 is a schematic diagram illustrating an example of a pressing force applied.

FIG. 5 is a schematic diagram illustrating an example of a pulling force applied.

FIG. 6 is a schematic diagram illustrating another example of a form of an operating unit in a controller.

FIG. 7 is a schematic diagram illustrating another example of a form of an operating unit in a controller.

FIG. 8 is a schematic diagram illustrating another example of a form of an operating unit in a controller.

FIG. 9 is a schematic diagram illustrating another example of a form of an operating unit in a controller.

FIG. 10 is a schematic diagram illustrating another example of a form of an operating unit in a controller.

FIG. 11 is an explanatory diagram of calibration using an orientation detection device.

### DESCRIPTION OF EMBODIMENTS

### First Embodiment

A first embodiment of the present invention will be described below with reference to the drawings.

### <Overall Structure of Controller>

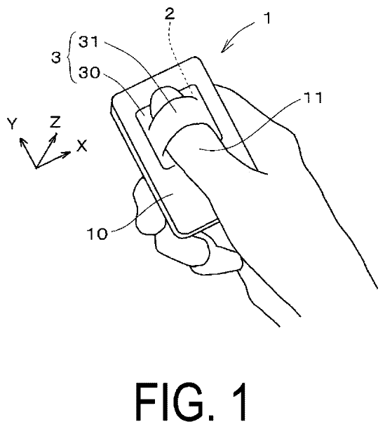

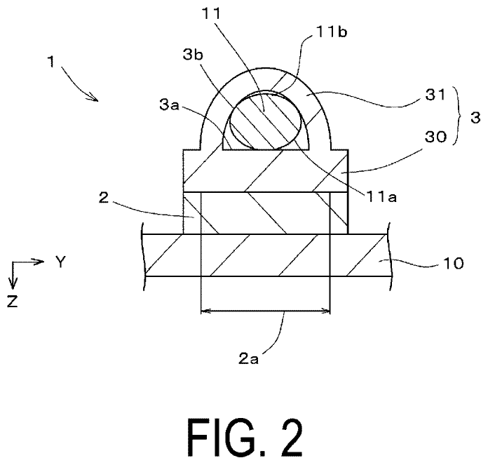

First, the overall structure of an input device 1 according to an embodiment of the present invention will be described with reference to FIGS. 1 and 2. FIG. 1 is a schematic diagram of a controller that detects a pressing force and a pulling force according to the present invention. FIG. 2 is a schematic diagram illustrating an example of the form of an operating unit in the controller in FIG. 1.

A controller 1 includes a housing 10, a film-type three-axis force sensor 2, and an operating unit 3 (see FIGS. 1 and 2).

The film-type three-axis force sensor 2 is disposed on the surface of the housing 10 and is configured to detect forces along three axes applied by a finger 11 of a user.

The operating unit 3 covers the surface of an active area 2a of the film-type three-axis force sensor 2. The operating unit 3 also has a pressing surface 3a to be pressed by a finger pad 11a of the finger 11; and a constraining surface 3b on which the finger 11 is to be constrained such that when the finger 11 moves in a direction away from the pressing surface 3a, a pulling force is applied to the surface of the active area 2a of the film-type three-axis force sensor 2.

Each configuration of the above will be described in more detail below.

### <Housing>

Examples of materials for the housing 10 include general-purpose resins such as polystyrene resins, polyolefin resins, ABS resins, AS resins, and AN resins. In addition, it is also possible to use general-purpose engineering resins, such as polyphenylene oxide-polystyrene resins, polycarbonate resins, polyacetal resins, polyacrylic resins, polycarbonate-modified polyphenylene ether resins, polybutylene terephthalate resins, polybutylene terephthalate resins, and ultra-high molecular weight polyethylene resins; and super-engineering resins, such as polysulfone resins, polyphenylene sulfide resins, polyphenylene oxide resins, polyarylate resins, polyetherimide resins, polyimide resins, liquid crystal polyester resins, and polyallyl heat-resistant resins.

### <Film-Type Three-Axis Force Sensor>

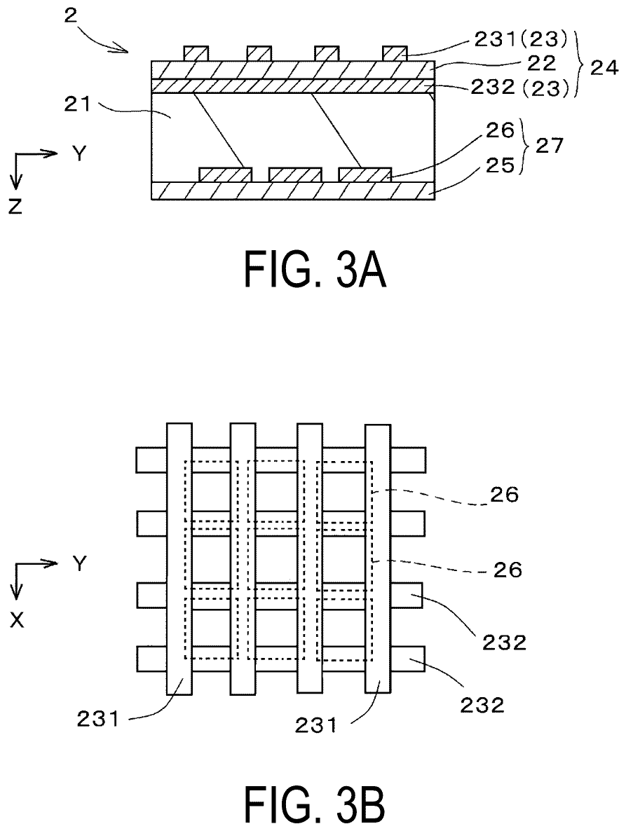

A capacitance type is generally known as the film-type three-axis force sensor 2. FIG. 3 is a schematic diagram illustrating an example of a film-type three-axis force sensor of a capacitance type.

The example of the film-type three-axis force sensor illustrated in FIG. 3 includes an upper electrode member 24 including an upper electrode 23 consisting of a plurality of electrodes formed on an upper support body 22; a lower electrode member 27 arranged so as to face the upper electrode member 24 and including a lower electrode 26 consisting of a plurality of electrodes on a lower support body 25; and an air layer or an elastic layer 21 sandwiched between the upper electrode member 24 and the lower electrode member 27. The lower electrode 26 of the lower electrode member 27 has an island pattern. Further, the upper electrode 23 of the upper electrode member 24 may consist of two layers of a front side upper electrode 231 and a back side upper electrode 232 formed on both sides of the upper support body 22 (see FIG. 3(a)), respectively. Additionally, the front side upper electrode 231 and the back side upper electrode 232 may consist of a plurality of linear patterns intersecting each other in plan view (see FIG. 3(b)). These patterns may be formed such that a part of the island pattern of the lower electrode 26 overlaps each of a part of the pattern of the front side upper electrode 231 and a part of the pattern of the back side upper electrode 232 in plan view.

In the example illustrated in FIG. 3(b), the crossing angle between the front side upper electrode 231 and the back side upper electrode 232 is 90° (i.e., orthogonal) such that the linear patterns of the front side upper electrode 231 extend in the X-axis direction and are arranged in the Y-axis direction and the linear patterns of the back side upper electrode 232 extend in the Y-axis direction and are arranged in the X-axis direction, but not limited thereto. When the crossing angle is orthogonal, the pattern of the lower electrode 26 is a rectangular grid, and when the crossing angle is not orthogonal, the pattern of the lower electrode 26 is a parallelogram grid.

The film-type three-axis force sensor 2 having such a configuration calculates the values of applied forces Fₓ, F_{y}, and F_{z} by utilizing a change in the capacitance value caused by a change in the distance between the electrodes when a force (the component forces in the X-, Y-, and Z-axis directions are Fₓ, F_{y}, and F_{z}, respectively) is applied.

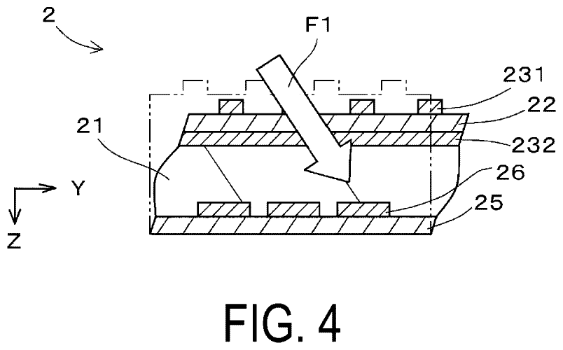

That is, regarding the upper electrode 23, when a force (pressing force F1) is applied to the surface of the film-type three-axis force sensor 2 obliquely downward by the finger 11, the elastic layer 21 is deformed, and the front side upper electrode 231 and the back side upper electrode 232 of the upper electrode member 24 move (see FIG. 4, the two-dot chain line in the drawing illustrates the state before pressing) in the horizontal direction (the X- and Y-axis directions) and the vertical direction (Z-axis direction) according to the strength of the force. Then, the distance and overlapping area change between the lower electrode 26 having the island pattern and the front side upper electrode 231, and between the lower electrode 26 having the island pattern and a back side upper electrode 232. This causes each of the capacitance values between the electrodes to change. Thus, by measuring a change of each capacitance value, not only the strength of the vertical force (the component force F_{z} in the Z-axis direction) but also the strength of the horizontal force (the component force F_{y} in the Y-axis direction in which the linear patterns of the front side upper electrode 231 are arranged, and the component force Fₓ in the X-axis direction in which the linear patterns of the back side upper electrode 232 are arranged) can be measured.

Examples of materials of the upper support body 22 and the lower support body 25 include not only a thermoplastic resin sheet such as acrylic, urethane, fluorine, polyester, polycarbonate, polyacetal, polyamide, or olefin or a thermosetting resin sheet, but also an ultraviolet-curable resin sheet such as cyanoacrylate. The film-type three-axis force sensor 2 including the upper support body 22 and the lower support body 25 can be disposed along the shape of the housing 10, and thus can be mounted on, for example, a column surface.

The upper electrode 23 and the lower electrode 26 can be composed of conductive materials. Examples of the conductive materials include metal films of gold, silver, copper, platinum, palladium, aluminum, rhodium, and the like; and conductive paste films in which conductive materials such as metal particles thereof, metal nanofibers thereof, or carbon nanotubes are dispersed in a resin binder, but not particularly limited. In the case of the metal films, examples of a forming method thereof include a method in which a conductive film is formed on an entire surface by plating, sputtering, vacuum deposition, ion plating, or the like, and then patterning is performed by etching. In the case of the conductive paste films, examples of a forming method include a method in which a direct pattern is formed by printing such as screen printing, gravure printing, or offset printing.

Examples of the elastic layer 21 include resilient synthetic resin sheets of silicone, fluorine, urethane, epoxy, ethylene-vinyl acetate copolymer, polyethylene, polypropylene, polystyrene, butadiene rubber, and the like; and stretchable nonwoven fabric sheets. In particular, elastic sheets of silicone resins such as silicone gel and silicone elastomer are more preferable because they have excellent durability and resilience in a wide range of temperatures from a low temperature to a high temperature. The elastic layer 21 is not limited to a sheet formed by a general sheet forming method such as extrusion, but may be a coating layer formed by printing, coater, or the like.

When a resin such as polyethylene, polypropylene, or polystyrene is selected as the material of the elastic layer 21, these synthetic resins alone have low resilience, so that gas is preferably finely dispersed in the synthetic resins to make them be in a foam state.

The capacitive film-type three-axis force sensor 2 is not limited to the one described above, and a known capacitive film-type three-axis force sensor 2 may be adopted. For example, the embodiments and modifications described in the aforementioned Patent Documents 1 and 2 can be applied.

### <Operating Unit>

The operating unit 3 covers the surface of the active area 2a of the film-type three-axis force sensor 2. The operating unit 3 also has a pressing surface 3a to be pressed by the finger pad 11a of the finger 11; and the constraining surface 3b on which the finger 11 is to be constrained such that when the finger 11 moves in a direction away from the pressing surface 3a, a pulling force is applied to the surface of the active area 2a of the film-type three-axis force sensor 2 (see FIGS. 1 and 2). In the example illustrated in FIGS. 1 and 2, the controller 1 has the constraining surface 3b of the operating unit 3 consisting of the surface on the finger 11 side of a band 31 covering a back 11b of the finger 11.

In the operating unit 3, a sheet portion 30, which covers the surface of the active area 2a of the film-type three-axis force sensor 2 and has the pressing surface 3a to be pressed by the finger pad 11a of the finger 11, is bonded to the surface of the film-type three-axis force sensor 2. In the operating unit 3, the band 31 is integrated with the sheet portion 30. Thus, when the finger 11 is moved away from the pressing surface 3a (e.g., obliquely upward direction), the band 31 to constrain the finger 11 pulls the sheet portion 30. This causes a pulling force F2 to act also on the surface of the active area 2a of the film-type three-axis force sensor 2 that is bonded to the sheet portion 30.

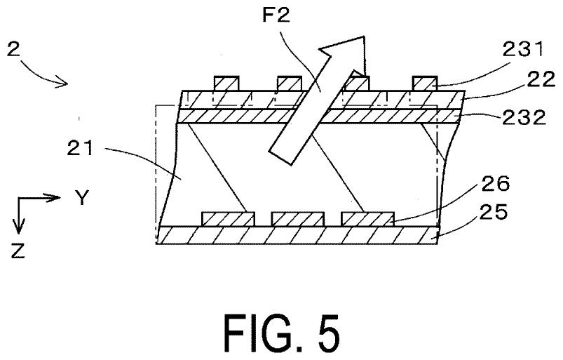

When the pulling force F2 also acts on the surface of the active area 2a of the film-type three-axis force sensor 2 as described above, the front side upper electrode 231 and the back side upper electrode 232 of the upper electrode member 24 move in the horizontal directions (X- and Y-axis directions) and the vertical direction (Z-axis direction) according to the strength of the pulling force (See FIG. 5, the two-dot chain line in the drawing is the state before pulling). Thus, the distance and overlapping area between the lower electrode 26 having an island pattern and the front side upper electrode 231 and between the lower electrode 26 having the island pattern and the back side upper electrode 232, change. This causes each of the capacitance values between the electrodes to change.

Thus, by measuring a change of each capacitance value, not only the strength of the vertical pulling force (the component force F_{z} in the Z-axis direction but in the opposite direction to that when the pressing force is detected) but also the strength of the horizontal pulling force (the component force F_{y} in the Y-axis direction in which the linear patterns of the front side upper electrode 231 are arranged, and the component force Fₓ in the X-axis direction in which the linear patterns of the back side upper electrode 232 are arranged) can be measured.

Various materials can be used for the sheet portion 30 and the band 31 of the operating unit 3. Examples include general resins such as ABS, polycarbonate, PS, and PET; rubbers such as silicone, NR, and NBR; cloth, and leather. For the sheet portion 30, it is easier to apply force in the horizontal direction (the X- and Y-axis directions) when a material with a non-slip surface is used. Further, for the band 31, it is better to use a material with elasticity because it comfortably fits the finger 11. Thus, rubber is the most suitable material for the sheet portion 30 and the band 31, of the operating unit 3. In the example illustrated in FIGS. 1 and 2, the sheet portion 30 and the band 31 of the operating unit 3 are illustrated as a single seamless object, but the operating unit 3 of the controller 1 according to the present invention is not limited thereto. For example, the sheet portion 30 and the band 31 may be prepared as separate members and joined together by bonding, sewing, or the like. The sheet portion 30 and the band 31, when prepared as separate members, can be made of different materials from each other.

### <Other Configuration>

A control circuit (not illustrated) is accommodated in the housing 10 and is electrically connected to the film-type three-axis force sensor 2.

The control circuit consists of a CPU and other electronic components.

A communication unit (not illustrated) may also be accommodated in the housing 10.

The communication unit communicates with an external electronic device via a wireless LAN such as WI-FI (Registered Trademark), BLUETOOTH (Registered Trademark), or NFC. The communication unit can communicate in one direction or both directions. The controller 1 of the present embodiment can control a plurality of external electronic devices either simultaneously or individually.

The external electronic device with which the communication unit is to communicate can be, for example, a head-mounted display or smart glasses used in XR, a smart television, a laptop computer, a desktop computer, a tablet computer, an audio system for an automobile, an automatic control device for home, work, or environment, or any other such device or system, but is not limited thereto.

Batteries (not illustrated) may be stored in the housing 10.

As the batteries, rechargeable batteries such as lithium batteries may be used. In the case of rechargeable batteries, the user can charge the batteries via USB or by simply placing the controller 1 on a charging pad. In addition, non-rechargeable batteries may be used as batteries 9 and taken out from inside the housing 10 to be replaced.

### Second Embodiment

Hereinafter, a second embodiment of the present invention will be described based on the drawings.

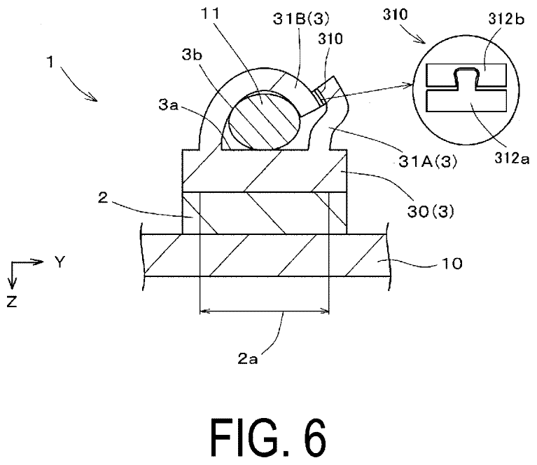

FIG. 6 is a schematic diagram illustrating another example of a form of an operating unit in a controller.

In the first embodiment, the finger 11 is inserted into a hollow space formed by the sheet portion 30 and the band 31 of the operating unit 3 from the opening end thereof, but the operating unit 3 of the controller 1 according to the present invention is not limited thereto. For example, as illustrated in FIG. 6, the band may be composed of two pieces (31A, 31B in the drawing) and have a locking structure 310, which switches states between binding and unbinding of the finger 11.

In the present embodiment, the locking structure 310 of the bands 31A and 31B is snap buttons 312a and 312b. As illustrated in FIG. 6, the general snap buttons 312a and 312b are metal or plastic fasteners composed of a pair of protruding and recessed parts (see an enlarged area in a circle of FIG. 6). This is a type of fastening by pressing both the parts together, and buttonholes are not required (also called press stud, snap fastener, snap closure, or the like). The snap buttons 312a and 312b are provided on the overlapping surfaces of the two bands 31A and 31B.

In the example illustrated in FIG. 6, the lengths of the two bands 31A and 31B are different from each other, and the locking structure 310 is provided on the right side in the drawing. However, the position of the locking structure 310 of the present invention is not limited thereto. For example, the lengths of the two bands 31A and 31B may be approximately equal to each other, and the locking structure 310 may be provided in the center of the drawing.

The present embodiment, as the materials of the two bands 31A and 31B, can use general resins such as ABS, polycarbonate, PS, and PET; rubbers such as silicone, NR, and NBR; cloth, leather, or the like, as in the first embodiment. More preferably, soft materials, which can be wound around the finger 11 and bound, are used for the bands 31A and 31B. Thus, rubber is the most suitable material for the bands 31A and 31B.

By configuring the controller 1 that detects a pressing force and a pulling force in this way, the present embodiment allows the finger 11 to be more easily attached to the operating unit 3 than the first embodiment. In other words, when inserting the finger 11 in the first embodiment, the opening area between the sheet portion 30 and the belt 31 is small in accordance with the cross-sectional size of the finger 11, so that the tip of the finger 11 tends to hit the side surface of the band 31. When the material of the band 31 is soft, the opening end of the belt 31 may be crushed. On the other hand, in the present embodiment, the finger 11 is placed on the pressing surface 3b of the sheet portion 30 with the bands 31A and 31B unwound, and the finger 11 is only tied so as to be wrapped with the bands 31A and 31B; thus, the opening area between the sheet portion 30 and the belt 31 does not need to be concerned when the finger 11 is attached to the operating unit 3.

The rest of the configuration is the same as that of the first embodiment, and description thereof is omitted.

### Third Embodiment

A third embodiment of the present invention will be described below based on the drawings.

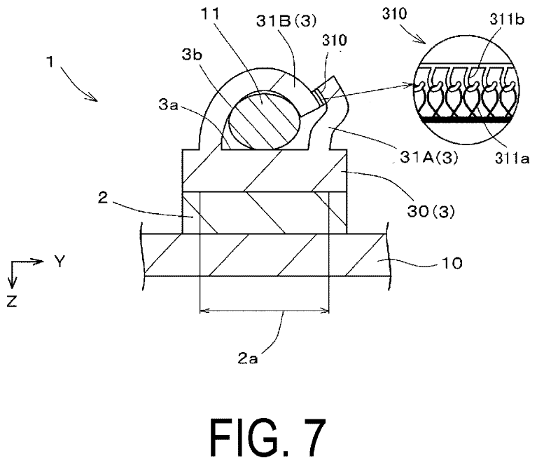

FIG. 7 is a schematic diagram illustrating another example of a form of an operating unit in a controller.

In the second embodiment, the snap buttons 312a and 312b have been illustrated as an example of the bands 31A and 31B having the locking structure 310, but the operating unit 3 of the controller 1 according to the present invention is not limited thereto. For example, as illustrated in FIG. 7, the locking structure 310 of the bands 31A and 31B may be a hook-and-loop fastener 311a and 311b.

The hook-and-loop fastener 311a and 311b is a fastener that can be attached and detached in a plane. The general hook-and-loop fastener 311a, 311b, which adheres simply by pressing a looped side 311a having a densely raised surface and a hooked side 311b raised in a hook shape together (see the enlarged portion inside the circle in FIG. 7), allows for easy attachment and detachment. In addition, there are other variations, such as a type in which both hooks and loops are implanted and there is no distinction between the hook surface and the loop surface; a click type in which surfaces are raised in a mushroom shape and the joint force is strong; and a serrated shark bite (shark teeth) type. The hook-and-loop fastener 311a and 311b is provided on the overlapping surfaces of the two bands 31A and 31B.

Thus configuring the controller 1 that detects a pressing force and a pulling force, enables adjusting the opening area between the sheet portion 30 and each of the belts 31A and 31B by shifting the circumferential position of the finger 11, to which the hook-and-loop fastener 311a and 311b adheres. This allows adjustment to the cross-sectional size of the finger 11 of each user, even when the user of the controller 1 changes to another person.

Other configurations are the same as those of the second embodiment, so that description thereof will be omitted.

### Fourth Embodiment

Hereinafter, a fourth embodiment of the present invention will be described based on the drawings.

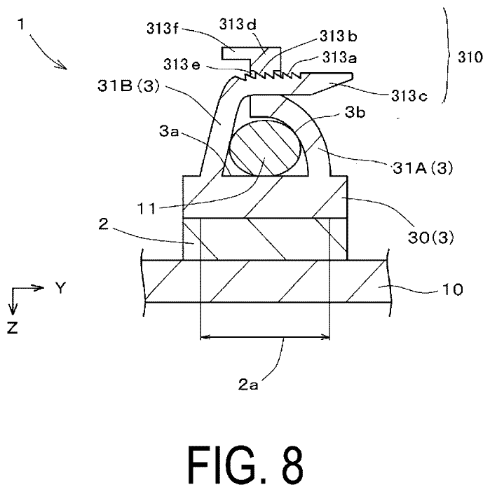

FIG. 8 is a schematic diagram illustrating another example of a form of an operating unit in a controller.

In the third embodiment, the hook-and-loop fastener 311a and 311b has been illustrated as an example of the locking structure 310 that can be adjusted to the cross-sectional size of the finger 11 of each user, but the operating unit 3 of the controller 1 of the present invention is not limited thereto. For example, as illustrated in FIG. 8, the locking structure 310 of the bands 31A and 31B may be a cable tie structure 313a to 313f of a reusable type.

The cable tie structure 313a to 313f will be described in more detail.

In the present embodiment, of the two bands 31A and 31B, the end of one band 31A is a head portion 313d having an opening 313e, which allows for insertion of a tapered tail portion 313c at the end of the other band 31B (see FIG. 8). A hook 313b is provided in the opening 313e of the head portion 313d of the band 31A. Sawteeth referred to as a serration 313a are provided on the surface of the band 31B facing the hook 313b.

The sawteeth are a series of protrusions having a right triangular cross-sectional shape, and the inclined surfaces of the protrusions face the tail portion 313c side. The shape of the hook 313b of the head portion 313d fits the sawteeth of the serration 313a. Thus, when the tail portion 313c coming out from the opposite side of the opening 313e of the head portion 313d is pulled, the hook 313b in the opening 313e is pushed by the inclined surfaces of the serration 313a of the band 31B, and moves up and down, reducing the opening area between the sheet portion 30 and each of the belts 31A, 31B. Even when the band 31B tries to recede through the head portion 313 of the band 31A, the sawtooth vertical surface of the serration 313a catches the vertical surface of the hook 313b, so that the band 31B does not recede, and the finger 11 can be tied and fixed.

In the locking structure 310 of the present embodiment, the cable tie structure 313a to 313f is a reusable type. The head portion 313 of the band 31A is provided with a lever 313f to be picked by fingers. By lifting this lever along the sawtooth vertical surface of the serration 313a, the hook 313b is released from the sawteeth of the serration 313a and the band 31B recedes. That is, the binding of the finger 11 can be released.

In the present embodiment, the two bands 31A and 31B hook the serration 313a to the hook 313b, thereby being fixed; thus, appropriate strength is required. That is, a material is used which can be bent into a ring shape as the whole band and has enough strength to prevent the hook and the sawteeth from being broken even when caught. Examples include nylon, polypropylene, and fluorine resin.

By thus configuring the controller 1 that detects a pressing force and a pulling force, the engagement position of the serration 313a and the hook 313b can be shifted in the circumferential direction of the finger 11, and the opening area between the sheet portion 30 and each of the belts 31A, 31B can be adjusted. This allows, as in the third embodiment, adjustment to the cross-sectional size of the finger 11 of each user, even when the user of the controller 1 changes to another person.

The other configurations are the same as those of embodiments 2 and 3, and thus a description thereof is omitted.

### Fifth Embodiment

Hereinafter, a fifth embodiment of the present invention will be described based on the drawings.

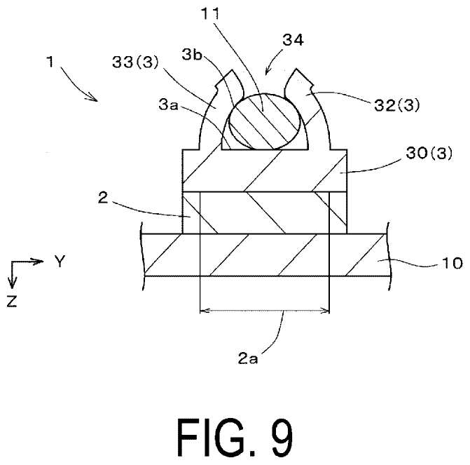

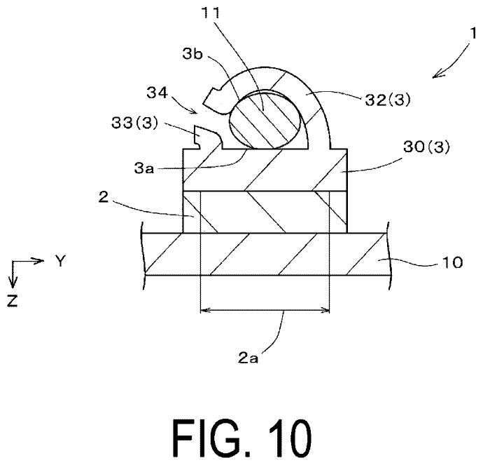

FIGS. 9 and 10 are schematic diagrams illustrating other configuration examples of the form of the operating unit in the controller.

In the first to fourth embodiments, the constraining surface 3b of the operating unit 3 consists of the finger 11 side surface of the band 31 or the two bands 31A and 31, which cover the back of the finger 11, but the operating unit 3 of the controller 1 according to the present invention is not limited thereto. For example, as illustrated in FIGS. 9 and 10, the constraining surface 3b of the operating unit 3 may consist of surfaces of clips 32 and 33 on the finger 11 side between which the finger 11 is sandwiched.

In the present embodiment, the clips 32 and 33 fit the finger 11 from the outside by pressing the circumferential surface of the finger 11. That is, the clips 32 and 33 consist of a pair of resin protrusions projecting from the pressing surface 3a of the operating unit 3 and surrounding the circumference of the finger 11 from opposite directions, and a gap 34 between the tips of the resin protrusions 32 and 33 is opened and closed by the elasticity of the resin protrusions 32 and 33 (see FIGS. 9 and 10). In the example illustrated in FIG. 9, the clips 32 and 33 have approximately equal lengths, and the gap 34 between the tips of the clips 32 and 33 is located in the center of the drawing. In the example illustrated in FIG. 10, one clip 32 is longer than the other clip 33, and the gap 34 between the tips of the clips is located on the left side of the drawing.

When the finger 11 is attached to the operating unit 3, the finger 11 is pushed into the clearance 34 from the outside of the self-standing clips 32 and 33. The clips 32 and 33 are elastic resin protrusions, so that the gap 34 between the tips of the clips are opened by the force that pushes the finger 11, then are deformed so as to receive the finger 11 in the space on the inner side of the clips 32 and 33. When the finger 11 enters the space on the inner side of the clips 32 and 33, the clips 32 and 33 having the gap 34 therebetween, which has been opened, are restored in a direction in which the gap 34 closes again. The finger 11 is fixed to the operating unit 3 by the force that restores the gap 34 to close it.

The tips of the clips 32 and 33 are preferably bent toward the outside so as to guide the finger 11 (see FIGS. 9 and 10).

Examples of elastic resin protrusion materials for the clips 32 and 33, include ABS, polycarbonate, nylon, polypropylene, and fluorine resin.

By thus configuring the controller 1 that detects a pressing force and a pulling force, it is easy to attach the finger 11 to the operating unit 3 compared with the first embodiment. In the present embodiment, the circumferential surface of the finger 11 is only pressed against the lips 32 and 33 and fitted thereto, so that it is not necessary to have concerns about the opening area between the sheet portion 30 and the belt 31 when the finger 11 is attached to the operating unit 3.

In the examples illustrated in FIGS. 9 and 10, the pressing surface 3a of the operating unit 3 is parallel to the surface of the film-type three-axis force sensor 2. However, the pressing surface 3a may form a curved surface so as to be in close contact with half of the finger pad side of the circumference of the finger 11 (not illustrated). This causes no clearance between the finger 11 and the pressing surface 3a of the operating unit 3, and thus there is less allowance when the finger 11 is moved. As a result, the response of the film-type three-axis force sensor 2 to the operation is not delayed, whereby more comfortable operation is achieved.

The rest of the configuration is the same as that of the first embodiment, and description thereof is omitted.

### Sixth Embodiment

Hereinafter, a sixth embodiment according to the present invention will be described based on the drawings.

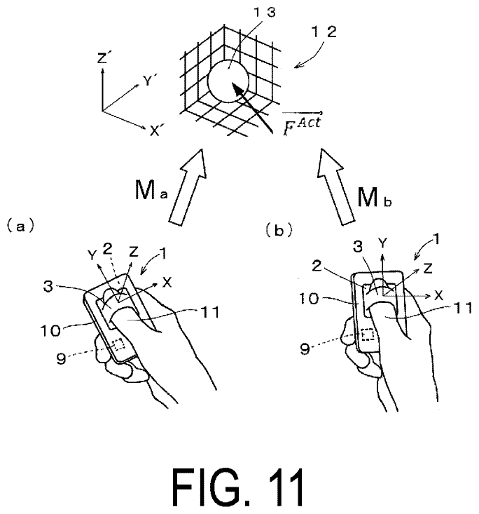

FIG. 11 is an explanatory diagram of calibration using an orientation detection device.

In the present embodiment, the controller 1 further includes an orientation detection device 9, which detects the user's operating orientation and is used for calibration of the film-type three-axis force sensor 2. The present embodiment will be described by taking as an example an application in which the controller 1 is used in an XR device and an object 13 having a spherical shape in a virtual space 12 is moved by the operation of the controller 1.

As for the force applied to the operating unit 3, the film-type three-axis force sensor 2 detects a force F_{z}^{Sens} in the direction normal to the plane and forces (i.e., shear forces) Fₓ^{Sens} and F_{y}^{Sens} of the two axes orthogonal to them. The detected result is expressed as F^{Sens} (arrow pointing to the right above the character), which is a vector quantity, as follows.

$$\vec{{F}^{sens}} = ( \begin{matrix}{F}_{y}^{Sens} \\ {F}_{y}^{Sens} \\ {F}_{z}^{Sens}\end{matrix} ) \qquad Equation 1$$

The above F^{Sens} (right-pointing arrow above the character) indicates the direction and strength of the force of the finger 11 pressing against the film-type three-axis force sensor 2.

In the virtual space 12 displayed on a head-mounted display or smart glasses of the XR device, according to F^{Sens} (right-pointing arrow above the character) applied to the controller 1, a force is also applied virtually to the object 13 having the spherical shape in the virtual space 12, and the object 13 moves. This allows the operator to move the object 13 freely in the three-dimensional virtual space 12, using only a finger.

The vector quantity of the force applied virtually to the object 13 displayed in the virtual space 12 is expressed as F^{Act} (right-pointing arrow above the character) for F^{Sens} (right-pointing arrow above the character), as follows.

$$\vec{{F}^{Act}} = M \vec{{F}^{Sens}} \qquad Equation 2$$

Here, a matrix M is determined by the orientation of the controller 1. Specifically, when the orientation of controller 1 is determined to have rotated by θₓ around the X-axis, by θ_{y} around the Y-axis, and by θ_{z} around the Z-axis in 3D space from the reference orientation, the matrix M is as follows.

$$M = {R}_{x} {R}_{y} {R}_{z} \qquad Equation 3$$

$$where {R}_{x} , {R}_{y} and {R}_{z} are as follows :$$

$${R}_{x} = ( \begin{matrix}1 & 0 & 0 \\ 0 & cos {θ}_{x} & - sin {θ}_{x} \\ 0 & sin {0}_{x} & cos {θ}_{x}\end{matrix} )$$

$${R}_{y} = ( \begin{matrix}cos {θ}_{y} & 0 & sin {θ}_{y} \\ 0 & 1 & 0 \\ - sin {θ}_{y} & 0 & cos {θ}_{y}\end{matrix} )$$

$${R}_{z} = ( \begin{matrix}cos {θ}_{z} & - sin {θ}_{z} & 0 \\ sin {θ}_{z} & cos {θ}_{z} & 0 \\ 0 & 0 & 1\end{matrix} )$$

The operator holds the controller 1 with his or her hand, so that the orientation of the controller 1 is changed regardless of the virtual space 12. In other words, as illustrated in FIG. 11, with respect to the virtual space 12, the controller 1 is positioned as illustrated in (a), or as illustrated in (b) with the controller 1 more upright than that in (a).

Thus, in order for the operator to operate the object 13 with respect to the virtual space 12 without any discomfort, it is necessary to cause a force F^{Act} (right-pointing arrow above the character) to act on the virtual space 12 in exactly the same manner in any orientation. That is, the sensor detection value needs to be calibrated according to the orientation. Specifically, based on the information on the operating orientation detected by the orientation detection device 9, F^{Sens} (right-pointing arrow above the character) is converted into F^{Act} (right-pointing arrow above the character) according to the inner product with each different matrix M (in FIG. 11, Mₐ, M_{b}).

As the orientation detection device 9, an acceleration sensor that outputs data corresponding to the inclination with respect to the gravity force direction stored in the controller 1, a magnetic sensor that outputs data corresponding to an azimuthal direction, a gyro sensor that outputs data corresponding to a rotational motion, or the like can be used.

In addition, the orientation detection device 9 may be a combination of the controller 1 and an external device. For example, an infrared light-emitting element is installed in the real space, a camera of the controller 1 captures the light from the infrared light-emitting element, and the image is analyzed to determine the operating orientation. Conversely, a camera may be installed in the real space, and an infrared light-emitting element may be installed in the controller 1.

This configuration enables determination of the orientation in which the controller 1 is operated in the real space and calibration, so that even when the operating orientation of the controller 1 changes, the direction in which a pressing force and a pulling force act on the object in the virtual space 12, which is seen by the head-mounted display or smart glasses, is the same. Thus, natural operation can be performed without any deviation between the movement of the user's hand and the virtual space 12.

The rest of the configuration is the same as those of the first to fifth embodiments, and description thereof is omitted.

### Modified Example

An embodiment of the present invention has been described above, but the present invention is not limited to the embodiment described above, and various modifications can be made without departing from the gist of the invention. In particular, the plurality of embodiments and modifications described herein can be combined as desired.

The fifth embodiment has described above that the clips 32 and 33 are composed of elastic resin protrusions, and the finger 11 is fixed by a restoration force, attributed to elasticity, in the direction in which the gap 34 between the tips of the clips is closed. However, elasticity is not necessary for the clips when they are combined with a spring as in a clothespin. That is, the clips only need to pinch the finger 11 to fix it.

In the above-described embodiments, the case where the film-type three-axis force sensor 2 is a capacitance type has been described, but the controller 1 according to the present invention is not limited thereto. As the film-type three-axis force sensor 2, a known type such as a piezoelectric type or a strain gauge type can be adopted.

In the above-described embodiments, the controller 1 includes a communication unit (not illustrated), but when the external electronic device is operated by wire, for example, with a USB cable, the communication unit may be omitted from the controller 1. In addition, a battery 5 may be omitted from the controller 1. Furthermore, the controller 1 may include a display device such as an LCD, a microphone, a speaker, or the like.

### REFERENCE CHARACTER LIST

1 Controller
2 Film-type three-axis force sensor
2a Active area
21 Elastic layer
22 Upper support body
23 Upper electrode
231 Front side upper electrode
232 Back side upper electrode
24 Upper electrode member
25 Lower support body
26 Lower electrode
27 Lower electrode member
3 Operating unit
3a Pressing surface
3b Constraining surface
30 Sheet portion
31, 21A, 31B Band
310 Locking portion
311a, 311b Hook-and-loop fastener
312a, 312b Snap button
313a Serration
313b Hook
313c Tail portion
313d Head portion
313e Opening
313f Lever
32, 33 Clip (resin protrusion)
34 Gap
9 Orientation detection device
10 Housing
11 Finger
11a Finger pad
11b Back
12 Virtual space
13 Object
F1 Pressing force
F2 Pulling force

1. A controller configured to detect a pressing force and a pulling force, comprising:
a housing;
a film-shaped force sensor disposed on a surface of the housing and configured to detect forces along three axes applied by a finger of a user; and
an operating unit covering a surface of an active area of the film-shaped force sensor and having a pressing surface to be pressed by a pad of the finger and a constraining surface on which the finger is to be constrained such that when the finger moves in a direction away from the pressing surface, a pulling force is applied to the surface of the active area of the film-shaped force sensor.

2. The controller according to claim 1, wherein
the constraining surface of the operating unit consists of a surface, facing the finger, of a band covering a back of the finger.

3. The controller according to claim 2, wherein
the band is composed of two pieces and has a locking structure configured to switch between a state in which the finger is bound and a state in which the finger is released.

4. The controller according to claim 3, wherein
the locking structure of the band is a hook-and-loop fastener.

5. The controller according to claim 3, wherein
the locking structure of the band is a reusable cable tie structure.

6. The controller according to claim 1, wherein
The constraining surface of the operating unit consists of a surface, facing the finger, of a clip configured to pinch the finger.

7. The controller according to claim 6, wherein
the clip is composed of a pair of resin protrusions projecting from the pressing surface, the pair of resin protrusions being configured to surround the circumference of the finger from opposite directions, and
a gap between respective tips of the resin protrusions is opened and closed by elasticity of the resin protrusions.

8. The controller according to claim 1, wherein the film-shaped force sensor is a capacitance sensor.

9. The controller according to claim 1, further comprising an orientation detection device configured to detect an operating orientation of the user and used for calibration of the film-shaped force sensor.
